(19) United States
(12) Patent Application Publication
(10) Pub. No.: US 2001/0010634 A1
(43) Pub. Date: Aug. 2, 2001

(54) Vehicle headlamp

(76) Inventor: Shoichiro Yokoi, Shizuoka (JP)

Correspondence Address: FISH & RICHARDSON P.C., Suite 2800, 45 Rockefeller Plaza, New York, NY, 10111, US

(21) Appl. No.: 09/772,413

(22) Filed: Jan. 30, 2001

(30) Foreign Application Priority Data
Jan. 31, 2000 (JP) P2000-021342
Aug. 11, 2000 (JP) P2000-243698

(51) Int. Cl. F21V 1/00; F21V 17/02

(52) U.S. Cl. 362/512; 362/539; 362/513; 362/284; 362/324

(57) ABSTRACT

A bulb supporting base fixed to a reflector of a vehicle headlamp is provided with a deviation-preventing member having first and second upper and lower resilient strips. The strips resiliently abut against a projection formed on a leg of a movable shade that shades light from the bulb when the movable shade is at either a low beam position or a high beam position.

### BACKGROUND OF THE INVENTION

1. Field of the Invention

The present invention relates to a vehicle headlamp in which a light distribution of a lighting fixture can be varied by moving a movable shade.

2. Description of the Related Art

The headlight of an automotive vehicle is constructed so that light from a light source is reflected off a reflector toward the front as high beam or low beam. The light distribution requirement for high beam is different from that for low beam. Thus, two light sources or two light source bulbs are used to switch between low beam and high beam.

A single light source is also known to be used in switching beams. Particularly, a two-bulb headlight that uses discharge bulbs is often employed.

For a single light source, a method for switching beams by moving a movable shade is known. A movable shade driven by a shade drive unit is moved between two prescribed positions, which provide different shielding of a reflected light from a light source.

A shade driving mechanism of the shade drive unit has components that vary dimensionally. To enhance the performance of the lighting fixture, it is preferable to provide a deviation-preventing member that prevents deviation of the movable shade from the prescribed positions. The member abuts against the movable shade when the movable shade is moved to the prescribed positions to prevent deviation of the movable shade from the prescribed position.

However, the simple deviation-preventing member that abuts against the movable shade generates a large hitting sound when the movable shade contacts the deviation-preventing member.

Such noise is generated not only when the beam is switched between the low beam and high beam by moving the movable shade, but also when the movable shade is moved to vary the light distribution of the lighting fixture.

An object of the present invention is to provide a vehicle headlamp configured such that while the light distribution of the lighting fixture is varied by moving the movable shade, the sound caused by the contact between the movable shade and the deviation-preventing member is reduced at low cost without sacrificing the performance of the lighting fixture.

### SUMMARY OF THE INVENTION

The object described above is achieved by adding a deviation-preventing member according to the present invention.

A vehicle headlamp according to the present invention comprises a light source, a reflector for reflecting a light from the light source to the front, a movable shade for shielding a part of light from the reflector, a shade drive unit for moving the movable shade between two prescribed positions providing different degrees of shielding of the light from the reflector, and a deviation-preventing member having a first and second resilient strips for resiliently abutting against the movable shade for preventing the movable shade from deviating substantially from the prescribed positions when the movable shade is moved to the respective prescribed positions.

The light source can be, for example, a discharge light emitting portion of the discharge bulb or a filament of an incandescent bulb such as a halogen bulb.

The movable shade includes a structure that shields light coming from the reflector.

The two positions providing different degrees of shielding refer to the prescribed positions of the movable shade to form a light distribution pattern for low beam or high beam. The positions can be arranged also to give other light distribution patterns.

The shade drive unit is constructed to move the movable shade between the two prescribed positions. The drive can be a solenoid or a pulse motor or other equivalents that can move the shade. The movement of the movable shade is not limited to any particular movements. It can be a rotary movement or a linear reciprocating movement.

As long as the deviation-preventing member comprises first and second resilient strips for abutting against the movable shade for preventing the movable shade from deviating from the prescribed positions, it is not limited to any particular structure or a material.

The vehicle headlamp provided with the deviation-preventing member according to the present invention has the following effects.

Each resilient strip configured to abut against the movable shade addresses the bouncing problem of the shade driving mechanism of the shade drive unit and the dimensional variation problem of the components of the assembly of the shade driving mechanism. It can prevent the movable shade from deviating from each prescribed position and reduce the sound generated by the abutment. Since the resilient strip applies a force to the movable shade when the movable shade is at the prescribed position, deviation of the movable shade not only in the direction of travel, but also in the orthogonal direction can be prevented by the frictional force between the resilient strip and the movable shade. Also vibrations of the movable shade during vehicle movement can be effectively prevented.

Since the deviation-preventing member can be easily formed by bending the metal plate or the like as a single member, the effects described above can be achieved at low cost. In addition, by configuring the deviation-preventing member as a single member, the accuracy of the relative position of the first and second resilient strips is increased. Consequently, the movable shade can be positioned accurately.

If the movement of the movable shade is a rotary motion about the forward-and-rear direction, the deviation-preventing member can be made compact. Thus, the cost can be further reduced by providing a projection projecting rearward on a shade leg extending from the shade body of the movable shade so that the upper and lower end surfaces of the projection abut against the respective resilient strips of the deviation-preventing member.

The sound caused by the contact between the movable shade and the deviation-preventing member is effectively reduced by forming an inclined surface for at least one of the resilient strips abutting against the projection. The surface can be inclined by a prescribed angle with respect to the direction of the radius of the rotary motion described above. Providing such an inclined surface reduces bouncing and shaking of the movable shade. Thus, flickering of the light distribution can be effectively eliminated.

Constructing the inclined surface as a pair of opposing inclined surfaces can further increase the positional accuracy of the movable shade and can further improve the light distribution performance of the lighting fixture.

Further, constructing at least one of the resilient strips with a plurality of resilient elements disposed to abut against the movable shade in stages can further reduce the sound generated by the contact between the movable shade and each resilient strip because the sound is spread over time in stages.

A failure of the shade drive unit, for example, can cause excessive movement of the movable shade and can lead to a deleterious effect on the light distribution performance of the lighting fixture. The excessive movement can be prevented by providing a fail-safe system—a stopper that abuts against the movable shade when the movable shade is moved to an extent beyond the prescribed position.

The stopper can be provided for one or each prescribed position.

### BRIEF DESCRIPTION OF THE DRAWINGS

FIG. 1 is a side cross-sectional view of the vehicle headlamp according to an embodiment of the present invention.

FIG. 2 is a detail view of part II in FIG. 1.

FIG. 3 is the headlamp shown in FIG. 1 in the direction of arrow III.

FIG. 4 is a detail perspective view of part II in FIG. 1.

FIG. 5 is a perspective view of a deviation-preventing member of the vehicle headlamp.

FIG. 6(a) and FIG. 6(b) illustrate switched positions for low beam and high beam by means of a shade drive unit of the vehicle headlamp according to the present invention.

FIG. 7 is a perspective view of another example of the deviation-preventing member.

FIG. 8 illustrates a variation of the switching of the beam.

FIG. 9 is a detail view showing a portion of FIG. 8.

FIG. 10 illustrates another variation of the switching of the beam.

FIG. 11 illustrates still another variation of the switching of the beam.

### DETAILED DESCRIPTION OF THE PREFERRED EMBODIMENTS

Embodiments of the present invention are described with reference to the drawings.

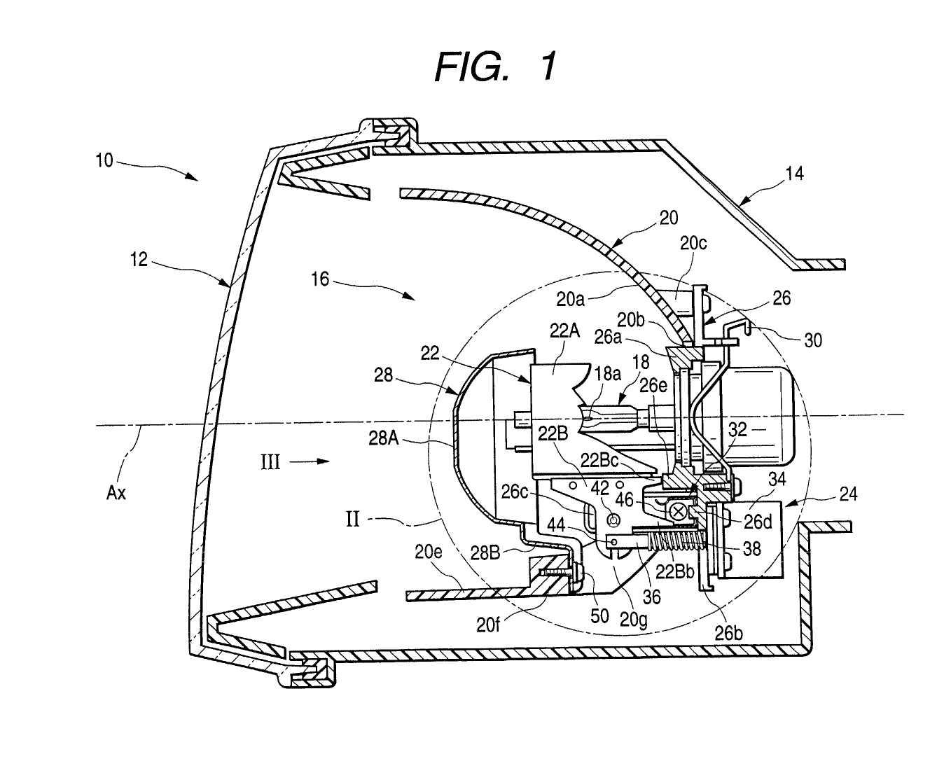

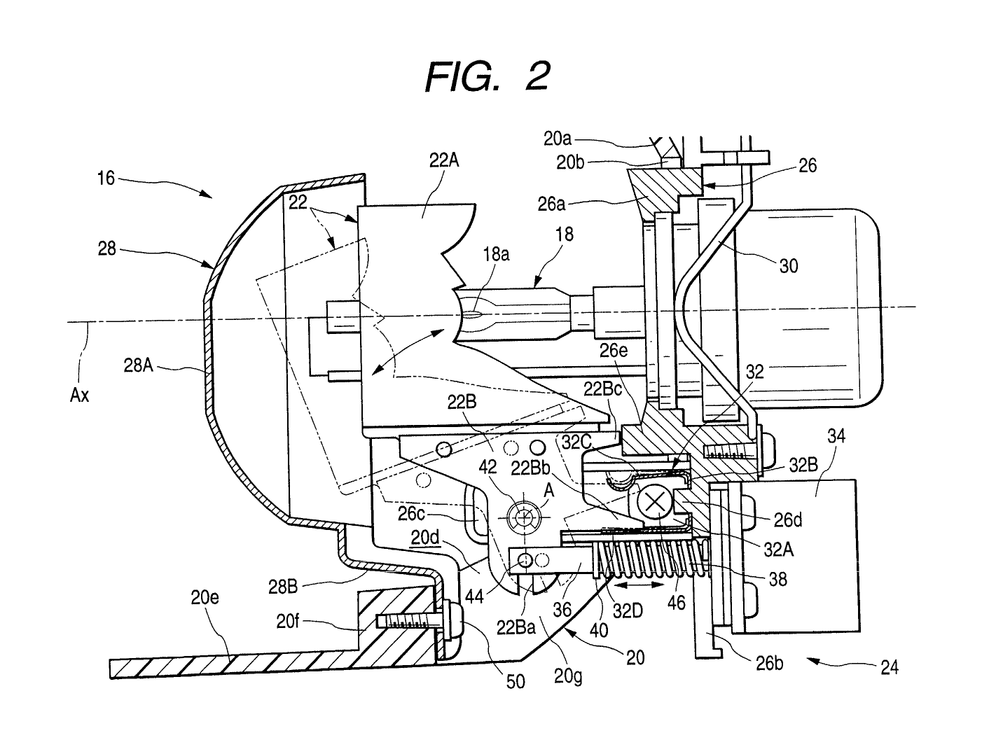

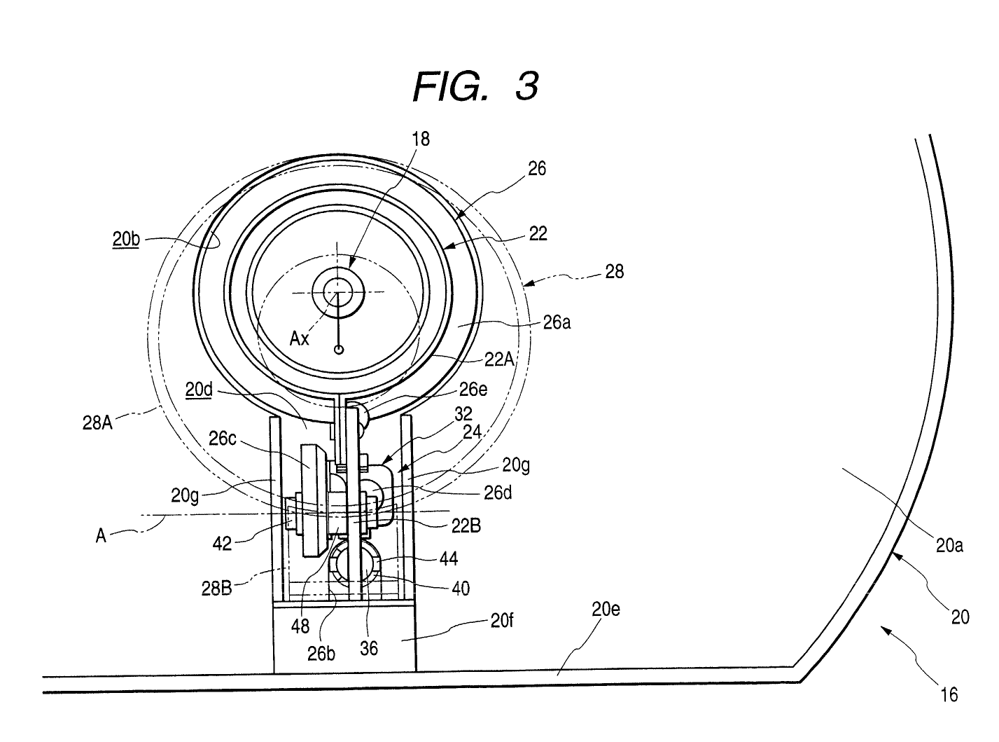

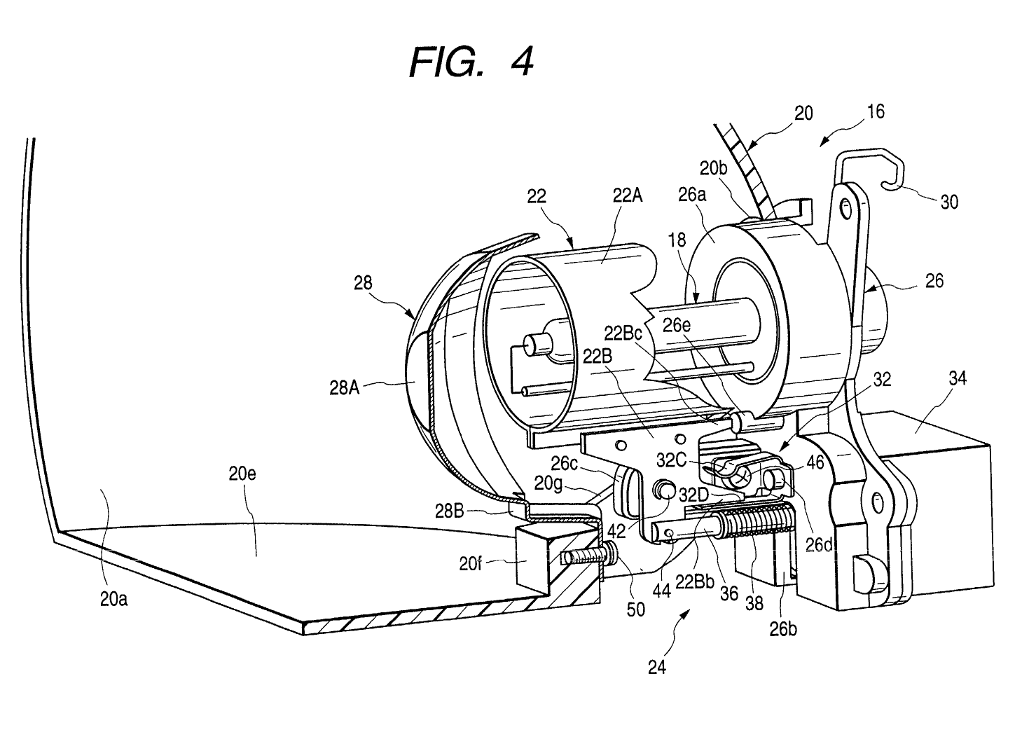

FIG. 1 is a side sectional-view of a headlamp for an automotive vehicle according to an embodiment of the present invention. FIG. 2 is a detail view of the portion II of FIG. 1. FIG. 3 is a headlamp shown in FIG. 1 as seen in the direction shown by arrow III. FIG. 4 is a perspective detail sectional-view of portion II of FIG. 1.

In FIG. 1, the headlamp for an automotive vehicle 10 according to the present invention comprises a reflector unit 16 mounted in a light chamber comprising a transparent cover 12 and a lamp body 14. The lamp body 14 can tilt in the vertical direction and the horizontal direction by means of an aiming mechanism, which is not shown.

The reflector unit 16 comprises a discharge bulb (metal halide bulb) 18, a reflector 20, a movable shade 22, a shade drive unit 24, a bulb supporting base 26, and a fixed shade 28.

The transparent cover 12 is formed so that an object on the other side may be distinctly seen. The reflector unit 16 is provided with a light distribution control mechanism. In other words, the reflector 20 of the reflector unit 16 includes a reflecting surface 20a for reflecting light from the discharge light emitting portion 18a of the discharge bulb 18 (light source) to the front, so that a beam forming a prescribed light distributing pattern is irradiated toward the front by the dispersing or deflecting mechanism of the reflecting surface 20a.

The discharge bulb 18 is fixedly supported to the reflector 20 via a bulb supporting base 26. The bulb supporting base 26 is formed by a die-cast molding method. The base 26 is inserted in the rearmost opening 20b of the reflector 20 from the rear and fixed by tightening screws through a plurality of bosses 20c provided on the back surface of the reflector 20.

The discharge bulb 18 is fixedly supported to an annular supporting portion 26a of the bulb supporting base 26 via a wire spring 30. When fixed, the discharge light emitting portion 18a of the discharge bulb 18 is positioned on the optical axis Ax of the reflector 20.

A rectangular opening 20d is formed on the reflecting surface 20a of the reflector 20 at the position below the rearmost opening 20b to communicate with the rearmost opening 20b, through which the shade driving mechanism of the shade drive unit 24 is to be accommodated. A bottom wall 20e is formed at the lower end of the reflecting surface 20a of the reflector 20, and a projection 20f for mounting a fixed shade is formed on the bottom wall 20e to project upwardly at the front-end portion of the rectangular opening 20d. A pair of elevating walls 20g is formed on the reflecting surface 20a of the reflector 20 on left and right sides of the rectangular opening 20d. The position of the upper edge of each elevating walls 20g is such that the front end portion is approximately at the same level as the upper surface of the projection 20f for mounting a fixed shade. The rear end portion is approximately at the same level as the lower end of the rearmost opening 20b. The intermediate portion gradually increases in height as it nears the rear end.

The movable shade 22 comprises a cylindrical shade body 22A with the rear edge forming complex projections and depressions and a plate shaped shade leg 22B extending downwardly from the lower end portion of the shade body 22A inclining somewhat toward the rear fixed with a rivet with respect to each other.

The movable shade 22 can take the low beam position shown in a solid line in FIG. 2 and the high beam position shown in a phantom line in the same figure by the shade drive unit 24. The movable shade 22 is constructed so that at the low beam position, the shade body 22A shields a part of a light incoming from the discharge light emitting portion 18a of the discharge bulb 18 to the reflecting surface 20a of the reflector 20 for accepting only the amount of light required for low beam irradiation. While at the high beam forming position, the shade body 22A in turn reduces the extent of shielding for a light incoming to the reflecting surface 20a for securing the amount of light required for high beam irradiation.

The shade drive unit 24 comprises a solenoid 34 screwed on the bulb supporting base 26 below the optical axis Ax of the reflector 20 and a return spring 38 mounted on a movable iron core 36 of the solenoid 34 for urging the movable iron core 36 toward the non-excited position.

The movable iron core 36 extends forward so as to pass through an inverted U-shaped groove 26b formed on the lower end of the bulb supporting base 26. The mid section of the core 36 is provided with an E-ring 40 for abutting the front end portion of the return spring 38 for receiving the resilient urging force of the return spring 38, and is bifurcated toward left and right at the tip portion thereof.

The movable shade 22 is supported at the mid section of a shade leg 22B by a supporting bracket 26c projecting forward from the bulb supporting base 26 via a shaft member 42 so as to rotate about the axis of rotation A extending from side to side. An annular spacer 48 is interposed between the shade leg 22B and the supporting bracket 26a, which minimizes rattling at the connecting portion between the shade leg 22B and the shaft member 42.

The movable shade 22 is engaged at the lower end of the shade leg 22B thereof to the tip portion of the movable iron core 36. A pin 44 is passed through the bifurcated tip portion of the movable iron core 36 from side to side, forming an elongated groove 22Ba at the lower end portion of the shade leg 22B extending vertically. The pin 44 is inserted in the elongated groove 22Ba. Though the distance between the shaft member 42 and the pin 44 varies as the movable shade 22 rotates, the variations of the distance is accommodated by sliding movement of the pin 44 in the elongated groove 22Ba.

The supporting bracket 26c of the bulb supporting base 26 is provided in the vicinity of the proximal end portion with a deviation-preventing member 32.

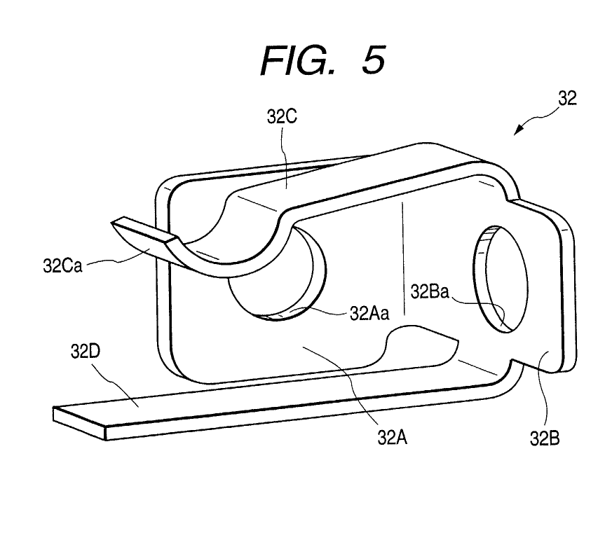

The deviation-preventing member 32 formed by bending a metal plate is shown in FIG. 5 as a discrete member. The member 32 comprises a screwing seat 32A formed with a screw insertion hole 32Aa, a positioning seat 32B formed with a positioning hole 32Ba, and first and second resilient strips 32C, 32D extending respectively from the upper end portion and the lower end position of the positioning seat 32B toward the front. The first resilient strip 32C has a plate shape that extends forward and slightly downward, and the tip portion 32Ca thereof formed in a semi-cylindrical shape projects downward. The second resilient strip 32D has a plate shape that extends forward and generally horizontally.

A boss 26d projecting forward is formed in the vicinity of the proximal end of the supporting bracket 26c on the front surface of the bulb supporting base 26. The deviation-preventing member 32 is mounted on the bulb supporting base 26 by inserting the boss 26d in the positioning hole 32Ba so that the positioning seat 32B abuts against the front surface of the bulb supporting base 26 and by tightening the screw 46 on the side surface of the supporting bracket 26c via the screw insertion hole 32Aa with the screwing seat 32A abutted against the side surface of the supporting bracket 26c.

The lower portion of the rear end surface of the shade leg 22B of the movable shade 22 is formed with a first projecting portion 22Bb (projecting portion) projecting rearward so as to be positioned between the resilient strips 32C and 32D of the deviation-preventing member 32. The first projecting portion 22Bb of a wedge shape has an upper end surface extending at a bevel slanting downwardly and a lower end surface extending generally horizontally.

The shade leg 22B is formed with a second projecting portion 22Bc projecting rearward on the upper portion of the rear end surface thereof. A stopper pin 26e (stopper) projecting forward is formed on the lower end portion of the annular supporting portion 26a on the front surface of the bulb supporting base 26. The extent of projection of the stopper pin 26e is determined so that the front end surface of the stopper pin 26e faces the rear end surface of the second projecting portion 22Bc of the shade leg 22B with a small clearance formed therebetween when the movable shade 22 is at the low beam position.

A fixed shade 28 for covering the movable shade 22 is provided in the vicinity of the front portion of the movable shade 22. The fixed shade 28 comprises a cap-shaped shade body 28A and a shade leg 28B being of a rectangular shape with one end open in cross section extending downward from the lower end portion of the shade body 28A and having the mid section offset rearwardly formed as a single piece. The fixed shade 28 is fixed to the rear surface of the projection 20f for mounting a fixed shade of the reflector 20 by tightening a screw 50 through the lower end portion of the shade leg 28B from the rear. The shade leg 28B of the fixed shade 28 is formed generally in the same width as that of the rectangular opening 20d of the reflector 20 to be clamped between the elevating wall 20g on both sides by inserting the shade leg 28B into the rectangular opening 20d.

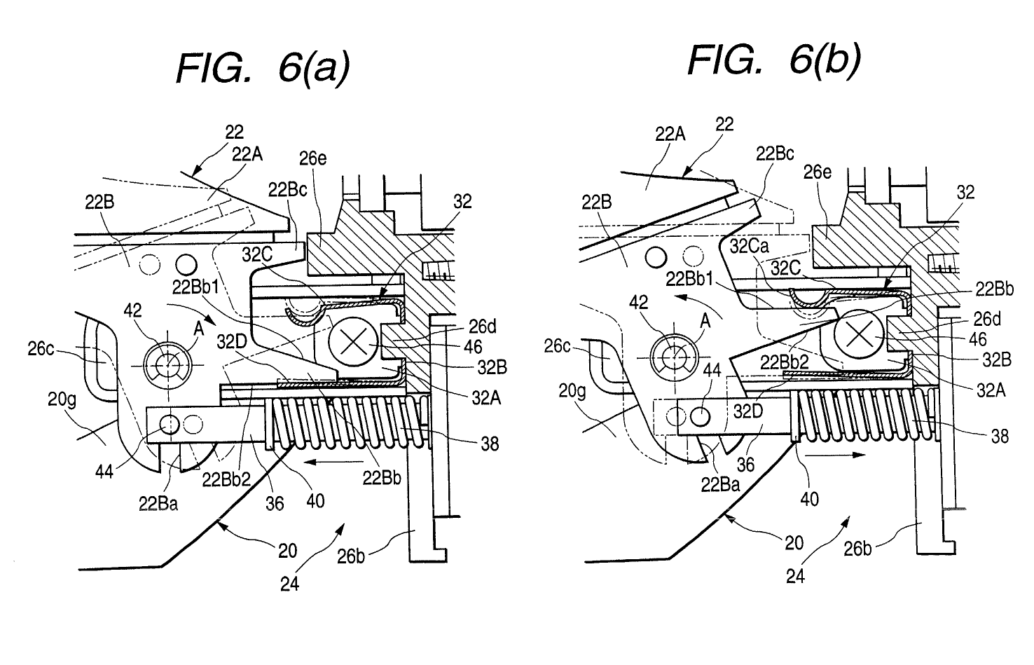

FIGS. 6(a) and 6(b) are detail views of a portion of FIG. 2 showing the switched positions of low beam and high beam carried out by the shade drive unit 24.

As shown in FIG. 6(a), when the beam change-over switch (not shown) of the shade drive unit 24 is switched from ON to OFF, the movable iron core 36 of the solenoid 34 is turned on to the non-excited state. The movable core 36 moves forward by the resilient urging force of the return spring 38, and the movable shade 22 turns rearward about the axis of rotation A. The movable shade 22 then abuts at the lower end surface 22Bb2 of the first projecting portion 22Bb of the shade leg 22B against the resilient strip 32D of the deviation-preventing member 32 immediately before the movable iron core 36 reaches the non-excited position, that is, immediately before the resilient urging force of the return spring 38 is destroyed. When the movable iron core 36 reaches the non-excited position, the movable shade 22 stops and is fixed to the low beam position where the resilient strip 32D is resiliently deformed by a resilient urging force remaining in the return spring 38.

When the movable shade 22 is turned rearward beyond the low beam position because of, for example, a failure of the shade drive unit 24, the second projecting portion 22Bc of the movable shade 22 abuts against the stopper pin 26e of the bulb supporting base 26 even with a slight excessive rotation. Thus, the further rotation is prevented.

On the other hand, as shown in FIG. 6(b), when the movable iron core 36 of the solenoid 34 is excited by turning the beam change-over switch ON, the movable iron core 36 moves rearward toward the excited position, thereby turning the movable shade 22 forward about the axis of rotation A. Then the movable shade 22 abuts against the tip portion 32Ca of the resilient strip 32C of the deviation-preventing member 32 at the upper end surface 22Bb1 of the first projecting portion 22Bb of the shade leg 22B immediately before the movable iron core 36 reaches the excited position. When the movable iron core 36 reaches the excited position, the movable shade 22 stops and is fixed in the high beam position with the resilient strip 32C resiliently deformed.

In the vehicle headlamp 10 according to the present invention, the movable shade 22, which can shield a part of light emitted from the discharge light emitting portion 18a of the discharge bulb 18 and reflected from the reflecting surface 20a of the reflector 20, is rotated between the low beam position and the high beam position that provide different degrees of shielding of an incident light. The bulb supporting base 26 is provided with a deviation-preventing member 32 having first and second resilient strips 32C, 32D mounted thereon, so that when the movable shade 22 is rotated to the low beam position or the high beam position, the respective resilient strips 32C, 32D resiliently abut against the movable shade 22 to prevent displacement of the movable shade 22 from the low beam position or the high beam position.

The resilient contact between the respective resilient strips 32C, 32D of the deviation-preventing member 32 and the movable shade 22 addresses the backlash of the shade driving mechanism of the shade drive unit 24 (a backlash at the connecting portion between the shade leg 22B and the shaft member 42, or at the connecting portion between the shade leg 22B and the movable iron core 36 of the solenoid 34, and a backlash of the movable iron core 36 in itself) or dimensional variations of the components. The resilient strips 32C and 32D prevent displacement of the movable shade 22 from the low beam position or the high beam position in the direction of rotation and reduce the sound caused by the abutment. In addition, since a force is applied from the resilient strips 32C, 32D to the movable shade 22 when the movable shade 22 is at the low beam position or at the high beam position, deviation of the movable shade 22 may be prevented not only in the direction of rotation of the movable shade 22 but also in the direction orthogonal thereto by a resistance force between the resilient strips 32C, 32D and the movable shade 22. Accordingly, vibrations of the movable shade 22 during vehicle movement may be effectively prevented in either the low beam position or the high beam position.

Since the deviation-preventing member 32 is integrally formed by bending a metal plate, the effects described above can be achieved at low cost. Also, the accuracy of positional relationship between the resilient strips 32C and 32D is increased. Thus, the movable shade 22 can be accurately positioned and the light distribution of the lighting fixture can be satisfactorily obtained.

According to the embodiment, the sound caused by the contact between the movable shade and the deviation-preventing member can be reduced at low cost while ensuring satisfactory light distribution performance.

According to the embodiment, since the shade leg 22B of the movable shade 22 is formed with a first projecting portion 22Bb projecting rearward, so that the upper and lower end surfaces 22b1, 22b2 of the first projecting portion abut against the resilient strips 32C, 32D of the deviation-preventing member 32 respectively, the deviation-preventing member 32 can be made compact. Thus, the cost can be further reduced.

According to the embodiment, when the movable shade 22 is turned rearward beyond the low beam position, the second projecting portion 22Bc formed on the shade leg 22B of the movable shade 22 abuts against the stopper pin 26c of the bulb supporting base 26 only with a slight excessive rotation. Therefore, a deleterious effect on the light distribution performance of the lighting fixture caused by excessive movement of the movable shade 22 because of, for example, the failure of the shade drive unit 24 can be prevented. Further, since the contact between the second projecting portion 22Bc and the stopper pin 26c is made when the movable shade 22 is moved slightly beyond the low beam position, reduction of the quantity of light irradiated at the low beam position because of excessive shielding by the movable shade 22 may be minimized even in the event of failure.

Another example of the present invention is explained below.

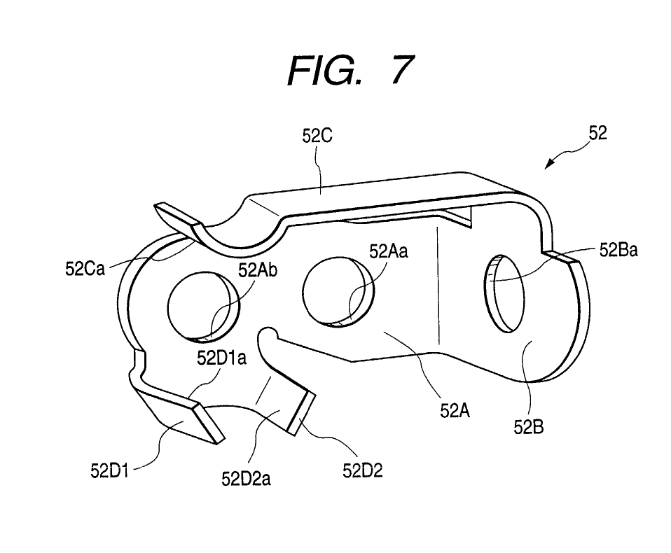

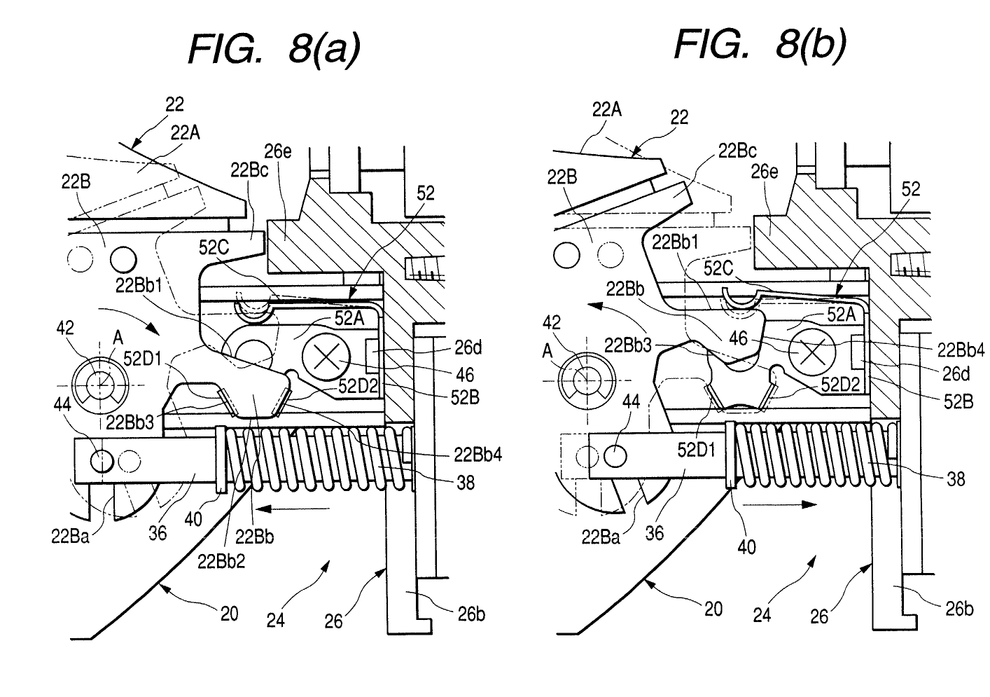

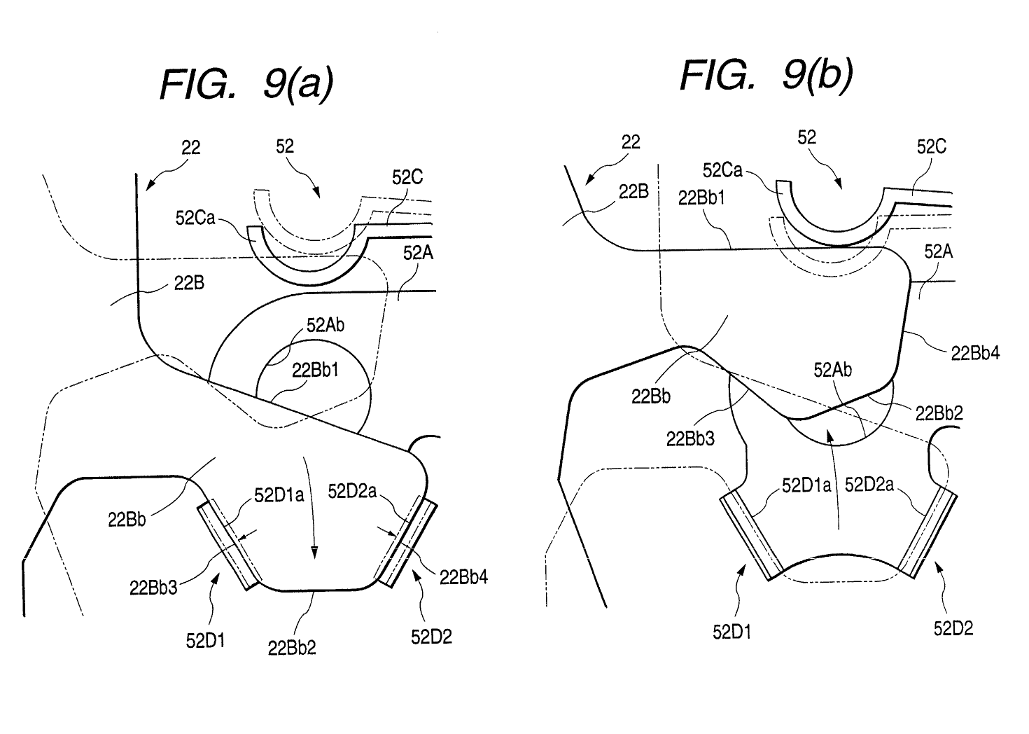

FIG. 7 is a perspective view of a deviation-preventing member. FIGS. 8(a) and 8(b) are views similar to FIGS. 6(a) and 6(b) showing switched beam positions. FIGS. 9(a) and 9(b) are detail views showing a portion of FIGS. 8(a) and 8(b).

This embodiment has the basic lighting fixture structure of the previous embodiment, but the configurations of the deviation-preventing member and the movable shade are different.

The deviation-preventing member 52 according to this embodiment comprises a screwing seat 52A being formed with a screw insertion hole 52Aa and a lightening hole 52Ab, a positioning seat 52B being formed with a positioning hole 52Ba, and first and second resilient strips 52C, and 52D1, 52D2. The deviation-preventing member 52 is mounted on the bulb supporting base 26 in the same manner as the deviation-preventing member 32 of the previous embodiment.

The first resilient strip 52C has a plate shape extending from the upper end portion of the positioning seat 52B toward the front, and the tip portion thereof 52Ca formed in a semi-cylindrical shape projects downward as in the previous embodiment. The second resilient strips 52D1, 52D2 formed as a pair of front and rear resilient strips arranged in a V-shape, extend sideward at the front end of the screwing seat 52A from the lower end portion. The resilient strips 52D1, 52D2 are inwardly inclined.

In this embodiment, the first projecting portion 22Bb on the shade leg 22B of the movable shade 22 formed in a deformed wedge shape is different from the wedge shape in the previous embodiment. The upper end surface 22Bb1 of the first projecting portion 22Bb extends at a bevel slanting downwardly, but the tip portion of the lower end surface 22Bb2 projects downwardly in a trapezoidal shape. A pair of inclined surfaces 22Bb3, 22Bb4 positioned at the front and rear of the lower end surface 22Bb2 abuts against the inclined surfaces 52D1a, 52D2a of the second resilient strips 52D1, 52D2 respectively. Each resilient strip 52D1, 52D2 resiliently deforms slightly toward the direction of inclination thereof.

As in the previous embodiment, when the movable shade 22 is rotated to the low beam position or the high beam position, the first and second resilient strips 52C and 52D1, 52D2 resiliently abut against the movable shade 22 to prevent the movable shade 22 from being displaced from either the low beam position or the high beam position. Therefore, the same effect as in the previous embodiment can be achieved.

In addition, since the portion of the surfaces of the second resilient strips 52D1 and 52D2 that abut against the first projecting portion 22Bb is formed on the surfaces 52D1a and 52D2a inclined by a prescribed angle with respect to the direction of the radius of the rotary motion of the movable shade 22, the sound generated by the contact between the movable shade 22 and the deviation-preventing member 52 can be effectively reduced. Moreover, the bouncing of the first projecting portion 22Bb can be reduced. Thus, vibrations of the movable shade 22 and the flickering of the light distribution can be reduced. Since a pair of inclined surfaces 52D1a, 52D2a opposing each other in a V-shape abuts against the inclined surfaces 22Bb3, 22Bb4 of the movable shade 22, the accuracy of positioning the movable shade 22 is further increased, thereby enhancing the light distribution performance of the lighting fixture.

In this embodiment, the positioning of the movable shade 22 at the low beam position at which the resilient strips abut against the movable shade 22 is important for the light distribution performance. The surfaces of abutment of the second resilient strips 52D1, 52D2 are constructed to incline by a prescribed angle with respect to the direction of the radius of the rotary motion of the movable shade 22. However, it is also possible to construct the resilient strips that abut against the movable shade 22 at the high beam position. The surface of abutment of the first resilient strip 52C can be inclined by a prescribed angle with respect to the direction of radius of the rotary motion of the movable shade 22. This can further enhance the light distribution performance of the lighting fixture.

Another example of the present invention will be explained below.

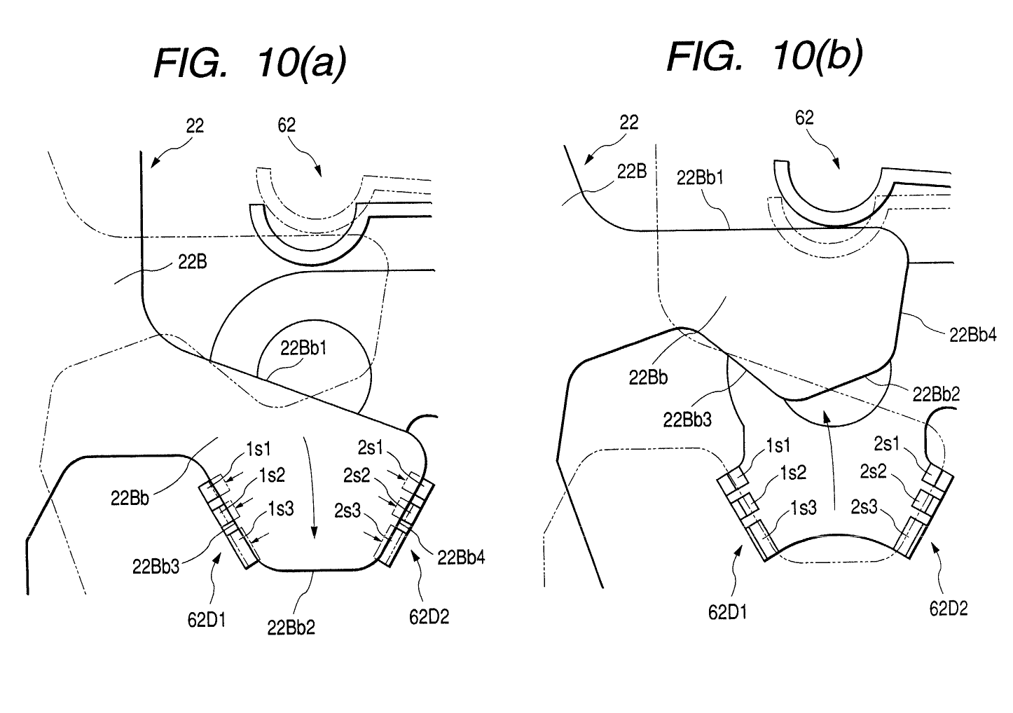

FIGS. 10(a) and 10(b) have views similar to FIGS. 9(a) and 9(b), showing a switched position.

The deviation-preventing member 62 of this embodiment also comprises the second resilient strips 62D1, 62D2 comprising a pair of front and rear resilient strips arranged in a V-shape. Further, resilient strips 62D1, 62D2 each comprises a plurality of resilient strip elements disposed to abut against the movable shade 22 in stages.

More specifically, the front resilient strip 62D1 comprises three resilient strip elements 1s1, 1s2, and 1s3, and the rear resilient strip 62D2 comprises three resilient strip elements 2s1, 2s2, and 2s3. The uppermost resilient strip elements lsl and 2s1 are inclined inwardly with respect to the next resilient strip elements 1s2 and 2s2, and the resilient strip elements 1s2 and 2s2 are inclined inwardly with respect to the lowermost resilient strip elements 1s3, 2s3.

Accordingly, when the movable shade 22 is rotated to the low beam position, the respective resilient strips 62D1, 62D2 abut against the movable shade 22 in the following order: the resilient strip elements 1s1, 2s1, the resilient strip elements 1s2, 2s2, and the resilient strip elements 1s3, 2s3. The width of the lowermost resilient strip elements 1s3, 2s3 are wider than those of other resilient strip elements for positioning the movable shade 22 accurately at the low beam position.

By the configuraton of this embodiment, the sound generated by the contact between the movable shade 22 and the respective resilient strip elements is reduced further because the sound is spread over time in stages.

Another example of the of the present invention is explained below.

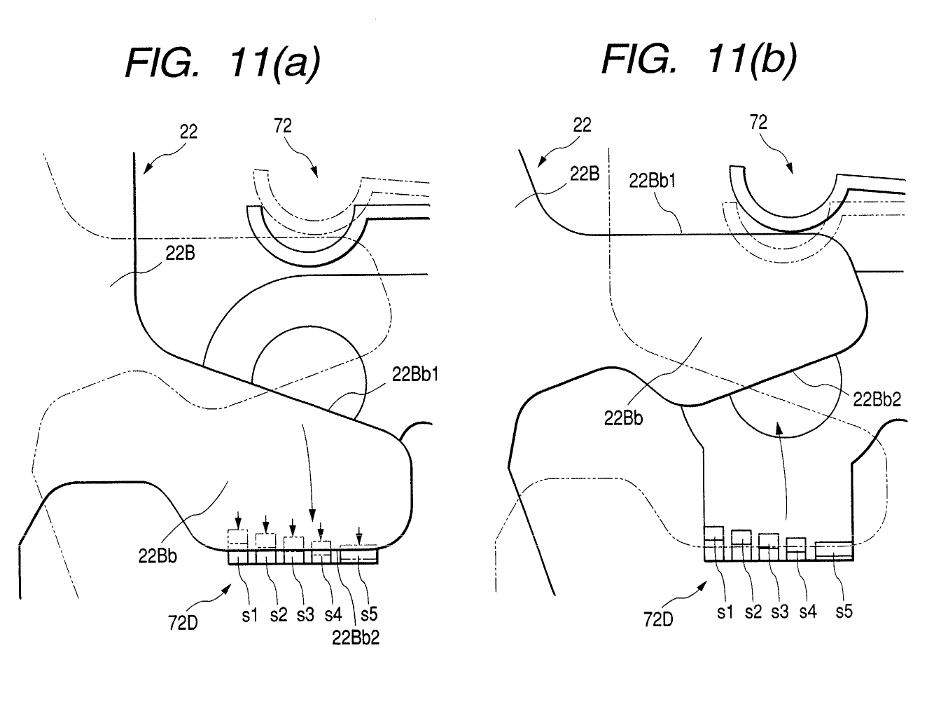

FIGS. 11(a) and 11(b) have views similar to FIG. 10, showing a switched position. A deviation-preventing member 72 according to this embodiment comprises a second resilient strip 72D having a resilient strip extending in the forward-and-rear direction instead of a pair of the front and rear resilient strips 62D1, 62D2 arranged in a V-shape. The resilient strip 72D comprises five resilient strip elements s1, s2, s3, s4 and s5, arranged to abut with the movable shade 22. The respective resilient strip elements s1, s2, s3, s4, and s5 incline inwardly, and the extent of inclination decreases gradually in the order given.

In this embodiment, the tip portion of the lower end surface 22Bb2 of the first projecting portion 22Bb on the shade leg 22B of the movable shade 22 linearly extends in the forward-and-rear direction. When the movable shade 22 is rotated to the low beam position, the lower end surface 22Bb2 abuts against the resilient strip 72D. The resilient strip 72D abuts against the movable shade 22 in stages from the resilient strip element in the order of s1, s2, s3, s4, s5 and resiliently deforms toward the direction of inclination thereof. The width of the resilient strip element s5 that abuts against the movable shade 22 is wider than other resilient strip elements for ensuring accurate positioning of the movable shade 22 at the low beam position.

The sound generated by the contact between the movable shade 22 and the respective resilient strip elements are further reduced because the sound is generated over time in stages.

The present invention claims priorities from Japanese patent applications serial no. 2000-021342 and no. 2000-243698, which are incorporated herein by these references in its entirety.

Other implementations are within the scope of the following claims.

What is claimed is:

1. A vehicle headlamp comprising:
a light source;
a reflector for reflecting light from the light source;
a movable shade for shielding light reflected from the reflector;
a shade drive unit for moving the movable shade between two prescribed positions; and
a deviation-preventing member having first and second resilient strips for resiliently abutting against the movable shade.

2. The vehicle headlamp as set forth in claim 1 wherein the member is configured to prevent the movable shade from deviating from one or the other prescribed position when the movable shade is moved to the respective prescribed position.

3. A vehicle headlamp as set forth in claim 1 wherein the movable shade comprises a shade body and a shade leg extending downwardly from the shade body; the shade leg is formed with a projecting portion projecting rearward such that the upper and lower end surfaces of the projection abut against the deviation-preventing member.

4. The vehicle headlamp as set forth in claim 3 wherein the surface of at least one of the first and second resilient strips is inclined by a prescribed angle with respect to the direction of radius of a rotary motion.

5. The vehicle headlamp as set forth in claim 4 wherein the inclined surface is formed of a pair of opposing inclined surfaces.

6. The vehicle headlamp as set forth in claim 5, wherein the opposing inclined surfaces are inwardly inclined to deform toward the direction of inclination thereof when one of the upper and lower surfaces of the projection abuts against the opposing inclined surfaces.

7. The vehicle headlamp as set forth in claim 5 wherein the opposing inclined surfaces comprises a plurality of resilient strip elements arranged to abut against the movable shade in stages.

8. The vehicle headlamp as set forth in claim 7, wherein the opposing inclined surfaces are inwardly inclined to deform toward the direction of inclination thereof when one of the upper and lower surfaces of the projection abuts against the opposing inclined surfaces.

9. The vehicle headlamp as set forth in claim 8, each extent of inward inclination of the resilient strip elements is varied in stages.

10. The vehicle headlamp as set forth in claim 7, the width of one of the resilient strip elements that abut against the movable shades are varied from one of the others.

11. The vehicle headlamp as set forth in claim 1 wherein at least one of the first and second resilient strips comprises a plurality of resilient strip elements arranged to abut against the movable shade in stages.

12. The vehicle headlamp as set forth in claim 11, wherein the opposing inclined surfaces are inwardly inclined to deform toward the direction of inclination thereof when one of the upper and lower surfaces of the projection abuts against the opposing inclined surfaces.

13. The vehicle headlamp as set forth in claim 12, each extent of inward inclination of the resilient strip elements is varied in stages.

14. The vehicle headlamp as set forth in claim 11, the width of one of the resilient strip elements that abut against the movable shades are varied from one of the others.

15. The vehicle headlamp as set forth in claim 1 further comprising:
a stopper that abuts against the movable shade when the movable shade is moved beyond the prescribed position.
